(19) United States
(12) Patent Application Publication
(10) Pub. No.: US 2005/0224190 A1
(43) Pub. Date: Oct. 13, 2005

(54) Adjustable curtain assembly in permeability to light

(75) Inventor: Wen-Chong Huang, Taipei (TW)

Correspondence Address: NIKOLAI & MERSEREAU, P.A., 900 SECOND AVENUE SOUTH, SUITE 820, MINNEAPOLIS, MN, 55402, US

(73) Assignee: K.E. & Kingstone Co., Ltd., Taipei (TW)

(21) Appl. No.: 10/823,138

(22) Filed: Apr. 13, 2004

(51) Int. Cl. E06B 9/08

(52) U.S. Cl. 160/120

(57) ABSTRACT

A curtain assembly has a frame, a first curtain, a second curtain and a positioning device. The frame has a top portion, a bottom portion and two side portions mounted between the top portion and the bottom portion. The curtains are attached respectively to the top portion and the bottom portion of the frame and each has a permeability to light different from each other. The positioning device is mounted in the frame and connected to the first and second curtains to hold the first and second curtains at desired positions. Accordingly, a curtain assembly with an adjustable permeability to light and versatile in use is provided.

### BACKGROUND OF THE INVENTION

1. Field of the Invention

The present invention relates to a curtain assembly, and more particularly to a curtain assembly that is adjustable in permeability to light.

2. Description of Related Art

Curtains are mounted onto windows or doors to block sunlight and to make the inside environment comfortable for a user. When the curtain is extended or retracted, blockage of light by the conventional curtain will be adjusted based on needs of the user.

However, because a conventional curtain is always made of cloth, plastic material or the like, the permeability to light of the conventional curtain is not adjustable. The conventional curtain is not versatile in use especially at a specific location, such as an infant room or a bedroom in a rest home for aged. To change the permeability to light, the curtain must be extended or retracted. When the curtain is retracted, the interior of the room is visible to any person outside via windows or doors, such that private matters of the user cannot be hidden.

To overcome the shortcomings, the present invention tends to provide an adjustable curtain assembly to mitigate or obviate the aforementioned problems.

### SUMMARY OF THE INVENTION

The main objective of the invention is to provide a curtain assembly that is adjustable in permeability to light and is versatile in use. The curtain assembly has a frame, a first curtain, a second curtain and a positioning device. The frame has a top rod, a bottom rod and two side rods mounted between the top rod and the bottom rod. The curtains are attached respectively to the top rod and the bottom rod of the frame and each has a permeability to light different from each other. The positioning device is mounted in the frame and connected to the first and second curtains to hold the first and second curtains at desired positions.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a curtain assembly in accordance with the present invention;

FIG. 2 is a partial top plan view in partial cross section of the side rod and the curtain of the curtain assembly in FIG. 1;

FIG. 3 is a side plan view of the curtain assembly in FIG. 1 showing the two curtains are extended in half respectively;

FIG. 4 is an operational side plan view of the curtain assembly in FIG. 1 showing that the first curtain is completely extended and the second curtain is completely retracted;

FIG. 5 is an operational side plan view of the curtain assembly in FIG. 1 showing that the first curtain is completely retracted and the second curtain is completely extended;

FIG. 6 is an operational side plan view of the curtain assembly in FIG. 1 showing that both two curtains are completely retracted; and

FIG. 7 is a front plan view of the curtain assembly in FIG. 1.

### DETAILED DESCRIPTION OF PREFERRED EMBODIMENT

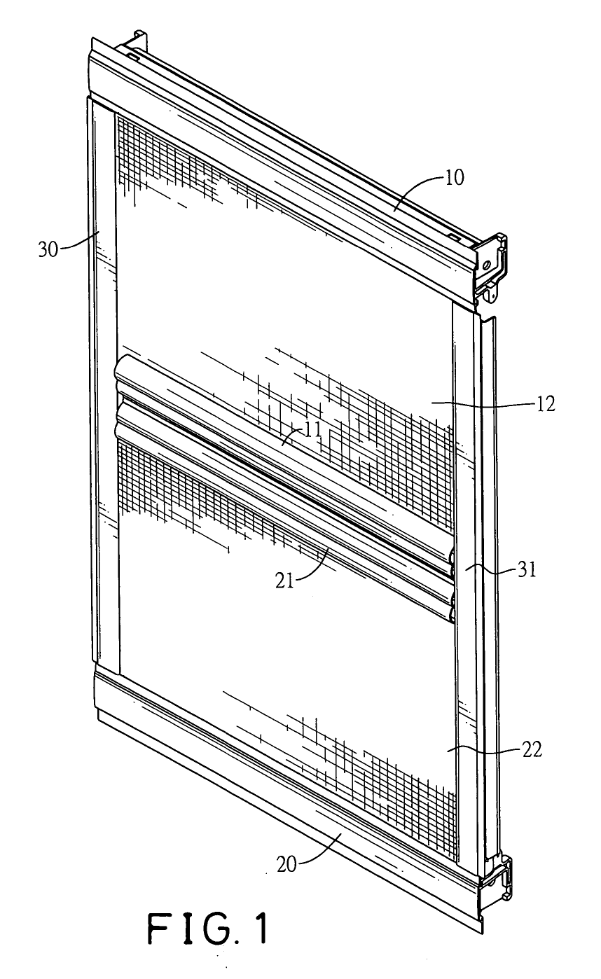

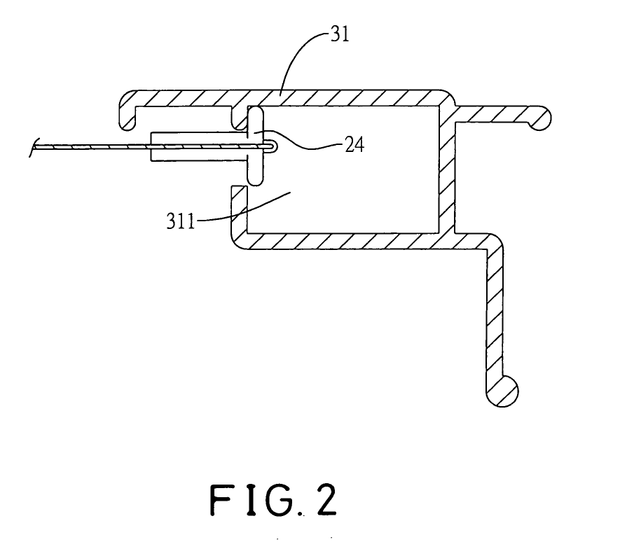

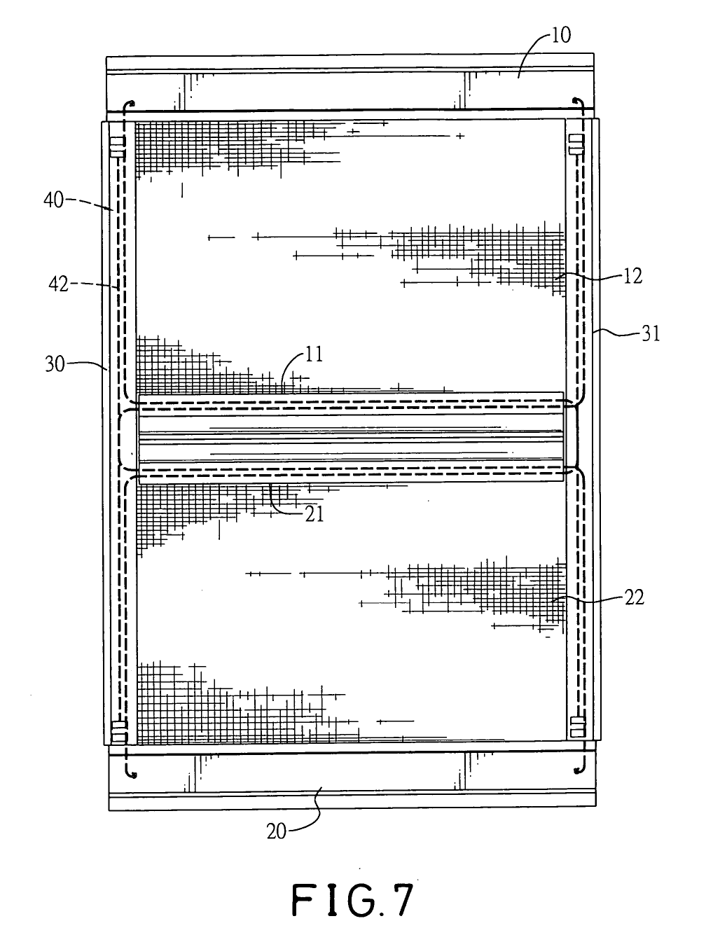

With reference to FIGS. 1 to 3 and 7, a curtain assembly in accordance with the present invention comprises a frame, a first curtain (12), a second curtain (22), a connected device and a positioning device (40). The frame comprises a top rod (10), a bottom rod (20) and two side rods (30,31). The top rod (10) is adapted to be secured on a top flange of a window or a door, and the bottom rod (20) is adapted to be secured on a bottom flange of the window or the door and corresponds to the top rod (10). The side rods (30,31) are mounted between the top rod (10) and the bottom rod (20) to make the frame rectangular. Each side rod (30,31) has a side provided with a rail channel (311) corresponding to each other.

The first and second curtains (12,22) are retractably mounted respectively on the top rod (10) and the bottom rod (20) of the frame. The curtains have a certain permeability to light. Each curtain (12,22) has a first end wound in a respective one of the top and bottom rods (10,20), a second end, two sides and two rails (24). The sides of each curtain (12,22) are slidably received respectively in the rail channels (311) in the side rods (30,31). The second end of the second curtain (22) is detachably connected to the second end of the first curtain (12) with the connecting device. In an optional embodiment, the connecting device comprises two end rods (11,21) attached respectively to the second ends of the curtains (12,22). Each end rod (11,21) has an engaging channel (13,23) corresponding to the engaging channel (13,23) in the other end rod (11,21). An engaging stick (14) is securely received in the engaging channel (13) in one of the end rods (11) and detachably engages with the engaging channel (23) in the other end rod (21). With the engagement between the engaging stick (14) and the engaging channels (13,23), the curtains (12,22) can be connected together.

In addition, the first permeability to light of the first curtain (12) is different from the second permeability to light of the second curtain (22). In an optional embodiment, the first curtain (12) has a first permeability to light that allows partial sunlight to permeate through the first curtain (12) at a predetermined ratio, such as 30%, 45%, 50% and so on. The first permeability to light at a ratio of 30% means the first curtain (12) allows 30% of light to permeate through the first curtain (12). The second curtain (22) has a second permeability to light that can block light completely or at a desired high ratio chosen from 51% to 100%, wherein the second permeability to light at a ratio of 100% means the second curtain (22) can completely block light.

The rails (24) are mounted respective to two sides of each curtain (12,22) and are slidably received respectively in the rail channels (311) in the side rods (30,31). With the engagements of the rails (24) and the rail channels (311) in the side rods (30,31), the movements of the curtains (12,22) are smooth.

The positioning device (40) is mounted on the frame and is connected to the curtains (12,22) to hold the curtains (12,22) at any desired position. In an optional embodiment, the positioning device (40) comprises four strings (42) each connected to the top and bottom rods (10,20) and extending through one of the end rods (11,21). Each string (42) has a first end connected to one end of the top rod (10) and a second end extending through one of the end rods (11,21) and attached to the bottom rod (20) at one end opposite to the end of the top rod (10) to which the first end is connected. Consequently, the curtains (12,22) will be held at any desired position by means of tensions provided by the strings (42).

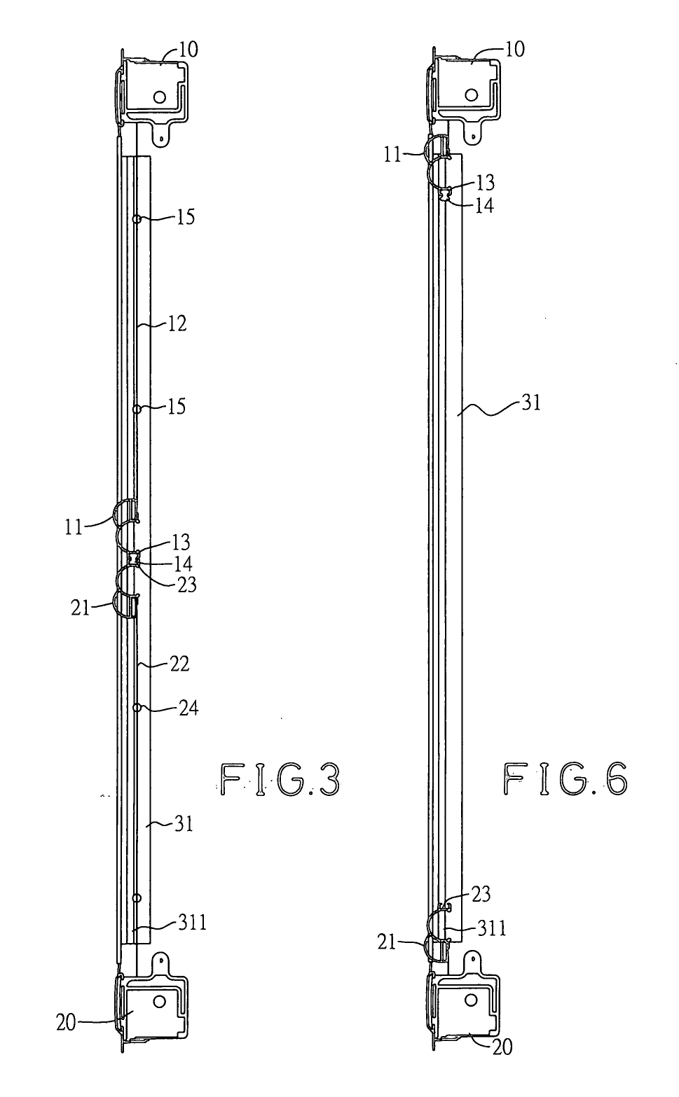

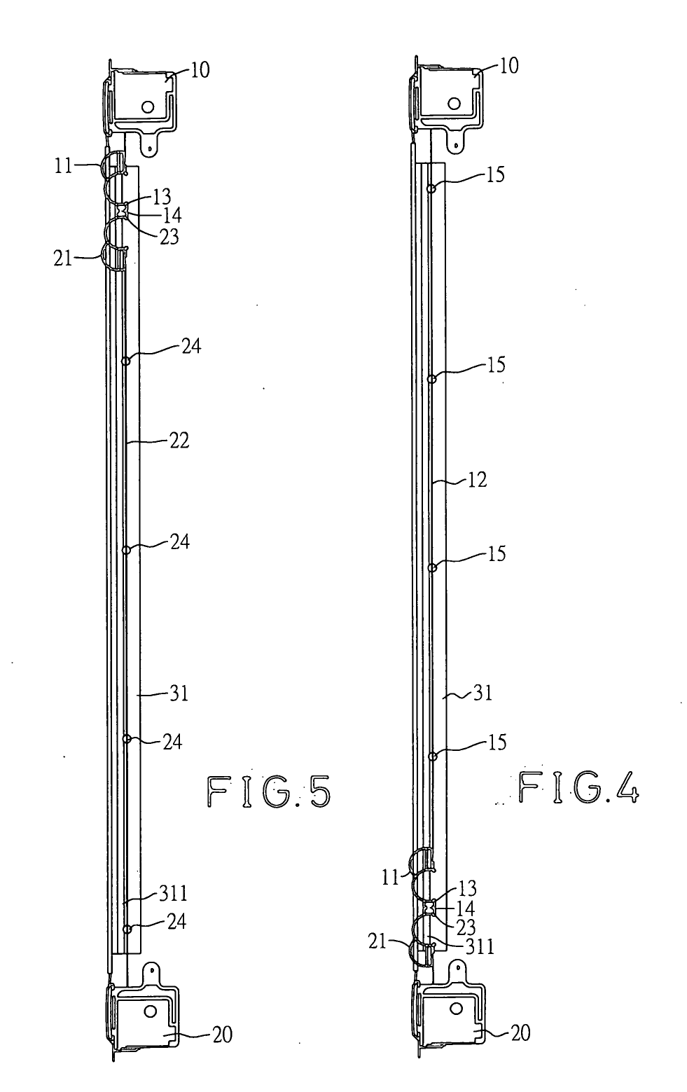

With such a curtain assembly, with reference to FIGS. 3 to 6, the permeability of the curtain assembly can be adjusted by means of expanding the curtains (12,22) at different positions. For example, the sunlight can be completely blocked when the second curtain (22) is fully extended and the first curtain (12) is fully retracted as shown in FIG. 4, whereby the private matters of the indoor user can be fully hidden and protected. Because the sides of the second curtain (22) are received respectively in the rail channels (311) in the side rods (30,31), there is not any gap between the second curtain (22) and the frame when the second curtain (22) is completely extended. Therefore, the sunlight can be completed block with the extended second curtain (22) to make the indoor a dark room.

The sunlight can be blocked at a desired ratio when the second curtain (22) is partially or fully retracted and the first curtain (12) is partially or fully extended as shown in FIGS. 3 and 5.

When the user wants to completely open the curtain assembly, the connecting device is detached and the curtains (12,22) are completely retracted respectively into the top and bottom rods (11,21). Therefore, the user can adjust the permeability to light of the curtain assembly based on the user's needs. The curtain assembly can serve as a see-through or light filter curtain, a room darkener or a black out curtain by means of adjusting the positions of the first and second curtains (12,22), such that the use of the curtain assembly is versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. The curtain assembly as claimed in claim 7 wherein the frame has
a top portion;
a bottom portion; and
two side portions mounted between the top portion and the bottom portion, with the first curtain attached to the top portion of the frame and having the first end wound in the top portion, with the second curtain attached to the bottom portion of the frame and having the first end wound in the bottom portion; and with the curtain assembly further comprising:
a positioning device mounted in the frame and connected to the first and second curtains to hold the first and second curtain at desired positions.

2. The curtain assembly as claimed in claim 1, wherein
each side portion has a side provided with a rail channel corresponding to each other; and
each one of the first and second curtains has two rails mounted respectively to two sides of the curtain and slidably received respectively in the rail channels in the side portions, with each of the two rails including a head extending perpendicular to the curtain and to the rail channel and located inside of the side portion and slidably abutting with the side of the side portion on opposite sides of the rail channel.

3. (canceled)

4. The curtain assembly as claimed in claim 6, wherein the second permeability to light of the second curtain blocks light through the first curtain at a desired high ratio; and
the first permeability to light of the first curtain allows partial sunlight through the second curtain at a desired ratio.

5. The curtain assembly as claimed in claim 12, wherein the positioning device comprises four strings each connected to the frame and extending through one of the end connectors,
wherein each string has a first end connected to one end of the frame and a second end extending through one of the end connectors and attached to the frame opposite to where the first end is connected.

6. A curtain assembly comprising;
a frame;
a first curtain attached to the frame and having a first permeability to light, a first end wound in the frame and a second end;
a second curtain attached to the frame and having a second permeability to light different from the first permeability to lights a first end wound in the frame and a second end; and
a connecting device mounted between the second ends of the first and second curtains to detachably connect the curtains together,
wherein the connecting device comprises
two end connectors attached respectively to the second ends of the curtains and each end connector having an engaging channel corresponding to the engaging channel in the other end connector; and
an engaging stick securely received in the engaging channel in one of the end connectors and detachably engaging with the engaging channel in the other end connector.

7. The curtain assembly as claimed in claim 1, wherein the second permeability to light of the second curtain blocks light through the first curtain at a desired high ratio; and
the first permeability to light of the first curtain allows partial sunlight through the second curtain at a desired ratio.

8. The curtain assembly as claimed in claim 7, wherein the positioning device comprises four strings each connected to the top and bottom portions and extending through one of the end connectors,
wherein each string has a first end connected to one end of the top portion and a second end extending through one of the end connectors and attached to the bottom portion at one end opposite to the end of the top portion to which the first end is connected.

9. The curtain assembly as claimed in claim 6,
wherein the second permeability to light of the second curtain blocks light through the first curtain at a desired high ratio; and
the first permeability to light of the first curtain allows partial sunlight through the second curtain at a desired ratio.

10. The curtain assembly as claimed in claim 11, wherein the positioning device comprises four strings each connected to the frame and extending through one of the end connectors,
wherein each string has a first end connected to one end of the frame and a second end extending through one of the end connectors and attached to the frame opposite to the end of where the first end is connected.

11. The curtain assembly as claimed in claim 6 further comprising: a positioning device mounted in the frame and connected to the first and second curtains to hold the first and second curtains at desired positions.

12. The curtain assembly as claimed in claim 4 further comprising: a positioning device mounted in the frame and connected to the first and second curtains to hold the first and second curtains at desired positions.

13. A curtain assembly comprising:
a frame having
a top portion;
a bottom portion; and
two side portions mounted between the top portion and the bottom portion;
a first curtain attached to the top portion of the frame and having a first permeability to light, a first end wound in the top portion and a second end; and
a second curtain attached to the bottom portion of the frame and having a second permeability to light different from the first permeability to light, a first end wound in the bottom portion and a second end detachably connected to the second end of the first curtain, wherein
each side portion has a side provided with a rail channel corresponding to each other; and
each one of the first and second curtains has two rails mounted respectively to two sides of the curtain and slidably received respectively in the rail channels in the side portions, with each of the two rails including a head extending perpendicular to the curtain and to the rail channel and located inside of the side portion and slidably abutting with the side of the side portion on opposite sides of the rail channel.

14. The curtain assembly as claimed in claim 13 further comprising: a positioning device mounted in the frame and connected to the first and second curtains to hold the first and second curtains at desired positions.

15. The curtain assembly as claimed in claim 2 further comprising:
a connecting device mounted between the first and second curtains to detachably connect the curtains together,
wherein the connecting device comprises two end connectors attached respectively to the second ends of the curtains and detachably engaging with the each other.

16. The curtain assembly as claimed in claim 15, wherein the positioning device comprises four strings each connected to the frame and extending through one of the end connectors,
wherein each string has a first end connected to one end of the frame and a second end extending through one of the end connectors and attached to the frame opposite to where the first end is connected.

17. The curtain assembly as claimed in claim 16, wherein the second permeability to light of the second curtain blocks light through the first curtain at a desired high ratio; and
the first permeability to light of the first curtain allows partial sunlight through the second curtain at a desired ratio.

18. The curtain assembly as claimed in claim 14, wherein the second permeability to light of the second curtain blocks light through the first curtain at a desired high ratio; and
the first permeability to light of the first curtain allows partial sunlight through the second curtain at a desired ratio.

19. The curtain assembly as claimed in claim 13, wherein the second permeability to light of the second curtain blocks light through the first curtain at a desired high ratio; and
the first permeability to light of the first curtain allows partial sunlight through the second curtain at a desired ratio.

20. The curtain assembly as claimed in claim 2 further comprising:
a connecting device mounted between the first and second curtains to detachably connect the curtains together,
wherein the connecting device comprises
two end connectors attached respectively to the second ends of the curtains and detachably engaging with the each other.

21. The curtain assembly as claimed in claim 20, wherein the second permeability to light of the second curtain blocks light through the first curtain at a desired high ratio; and
the first permeability to light of the first curtain allows partial sunlight through the second curtain at a desired ratio.
